(19) United States
(12) Patent Application Publication
(10) Pub. No.: US 2014/0327657 A1
(43) Pub. Date: Nov. 6, 2014

(54) INPUT DEVICE FOR TOUCH INTERFACE

(71) Applicant: Hui-Hu LIANG, Sioushuei Township (TW)

(72) Inventor: Chi-Tsung HUANG, Sioushuei Township (TW)

(21) Appl. No.: 13/912,560

(22) Filed: Jun. 7, 2013

(30) Foreign Application Priority Data
May 3, 2013 (TW) 201320235772.4

(51) Int. Cl. G06F 3/0354

(52) U.S. Cl. CPC G06F 3/03545
USPC 345/179

(57) ABSTRACT

An input device for a touch interface is formed of a main body having an opening, a sensor mounted to the main body, a moveable assembly movably mounted to the main body and having a driven member and a contact member, and a resilient member mounted and stopped against between the movable assembly and the main body. The contact member has an end portion and is mounted to the driven member. The driven member is mounted to the main body. The end portion extends out of the main body through the opening. The driven member and the sensor interact with each other to make the sensor generate an electric signal corresponding to the position of the driven member when the movable assembly is moved relative to the main body. In this way, the input device can accurately control operational force to faithfully reflect the touch perception.

### BACKGROUND OF THE INVENTION

1. Field of the Invention

The present invention relates generally to a touch interface and more particularly, to an input device for a touch interface.

2. Description of the Related Art

Currently, many electronic devices, like mobile phones and tablet computers, have touch interfaces. A user can make his or her finger press or move on the surface of the touch interface for data input or control of the electronic device, so the operation of the electronic device can be easier and more convenient.

To enable the input instruction for an electronic device with a touch interface to be more delicate and variable, for example, Taiwan Patent Pub. No. 201131434 discloses an input pen formed of a housing having a battery pack, a touch-control portion, and a resilient member. The touch-control portion is slidably mounted to an opening of the housing. The resilient member is mounted between the touch-control portion and a stop member inside the housing. When the stop member is moved toward the inside of the housing, the resilient member is compressed between the stop member and the touch-control portion to make the touch-control portion be electrically connected with the battery pack for generating signals, or the resilient recovery of the resilient member releases the electric connection between the touch-control portion and the battery pack.

Before the aforesaid input pen is used, the resilient member does not contact the stop member to form a gap therebetween. When the touch-control portion starts to contact an operation surface to be pressed, the touch-control portion moves toward the inside of the housing without encountering any resistance and until the resilient member is compressed by the touch-control portion and the stop member, a user can feel the touch perception of the touch-control portion subject to the resilience of the resilient member. In this way, when the user operates the input pen, the user initially fails to control the retrocession amount of the touch-control portion to allow the touch-control portion to be positioned on the operation surface and to control the movement of the touch-control-portion subject to the resilience of the resilient member, so it easily happens that the operational force cannot be accurately controlled and it fails to faithfully reflect the touch perception.

### SUMMARY OF THE INVENTION

The primary objective of the present invention is to provide an input device for a touch interface, which can accurately control operational force to faithfully reflect the touch perception.

The foregoing objective of the present invention is attained by the input device formed of a main body, a sensor, a moveable assembly, and a resilient member. The main body includes an opening. The sensor is mounted to the main body. The movable assembly is movably mounted to the main body and includes a driven member and a contact member. The contact member has an end portion. The driven member is mounted to the main body. The contact member is mounted to the driven member. The end portion extends out of the main body through the opening. The driven member and the sensor interact with each other to make the sensor generate an electric signal corresponding to the position of the driven member when the movable assembly is moved relative to the main body. The resilient member is mounted and stopped against between the movable assembly and the main body.

### BRIEF DESCRIPTION OF THE DRAWINGS

FIG. 1 is a perspective view of a first preferred embodiment of the present invention.

FIG. 2 is a partially perspective sectional view of the first preferred embodiment of the present invention.

FIG. 3 is similar to FIG. 2, illustrating that the movable assembly and the contact member arc mounted to the main body.

FIG. 4 is a sectional view of the first preferred embodiment of the present invention.

FIG. 5 is a partially sectional view of an alternative structure in accordance with the first preferred embodiment of the present invention.

FIG. 6 is similar to FIG. 5, illustrating another alternative structure in accordance with the first preferred embodiment of the present invention.

FIG. 7 is similar to FIG. 5, illustrating another alternative structure in accordance with the first preferred embodiment of the present invention.

FIG. 8 is a partially sectional view of a second preferred embodiment of the present invention.

FIG. 9 is a partially sectional view of an alternative structure in accordance with the second embodiment of the present invention.

FIG. 10 is a partially sectional view of a third preferred embodiment of the present invention.

FIG. 11 is a partially sectional view of an alternative structure in accordance with the third embodiment of the present invention.

### DETAILED DESCRIPTION OF PREFERRED EMBODIMENTS

Structural features and desired effects of the present invention will become more fully understood by reference to three preferred embodiments given hereunder. However, it is to be understood that these embodiments are given by way of illustration only, thus are not limitative of the claim scope of the present invention.

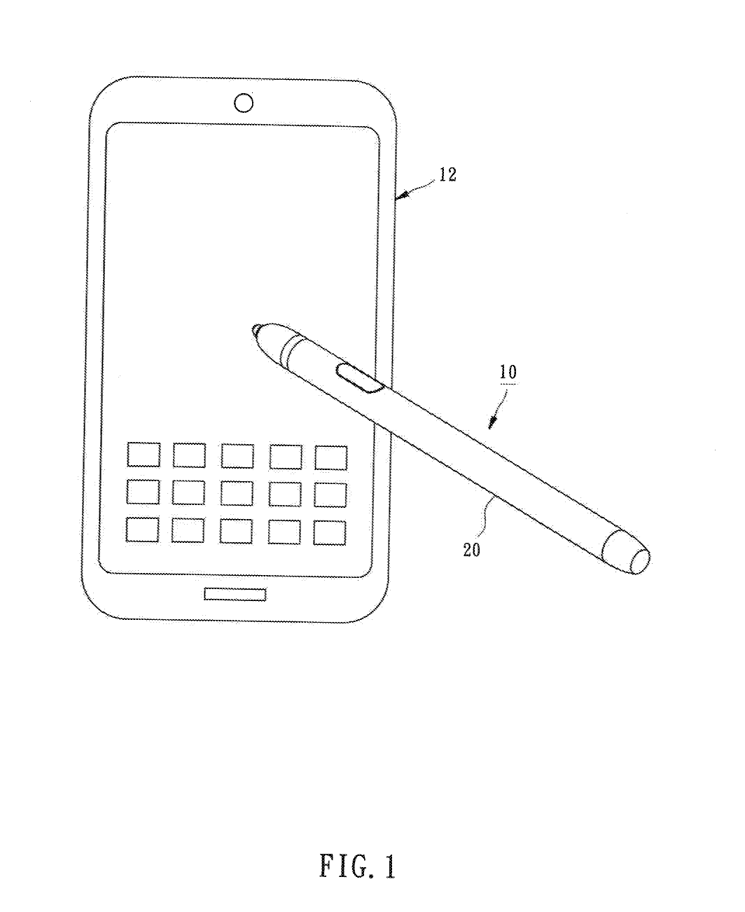

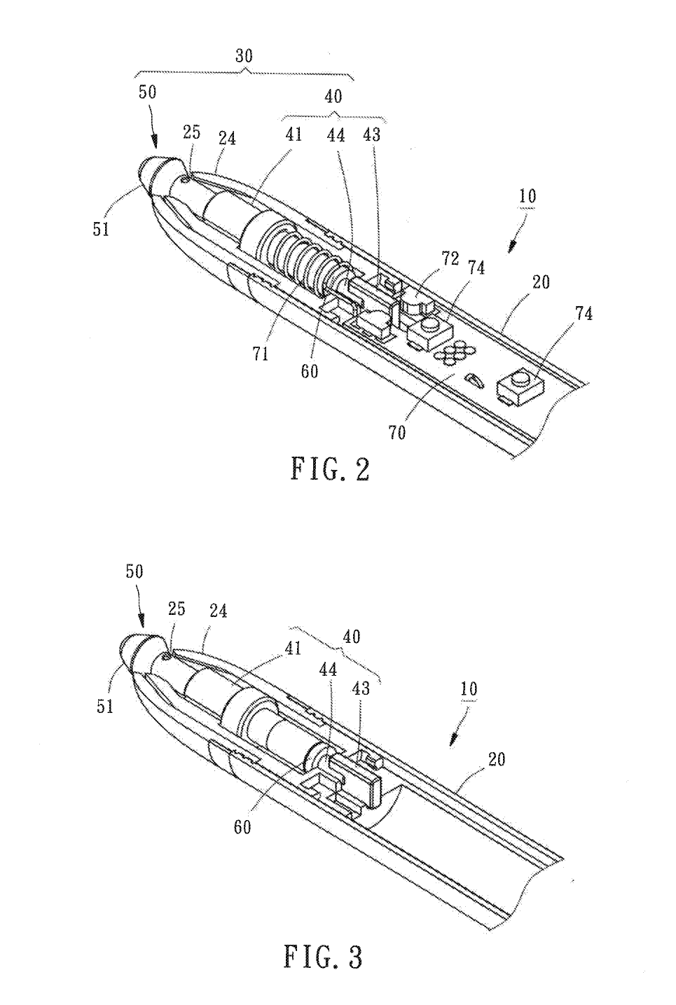

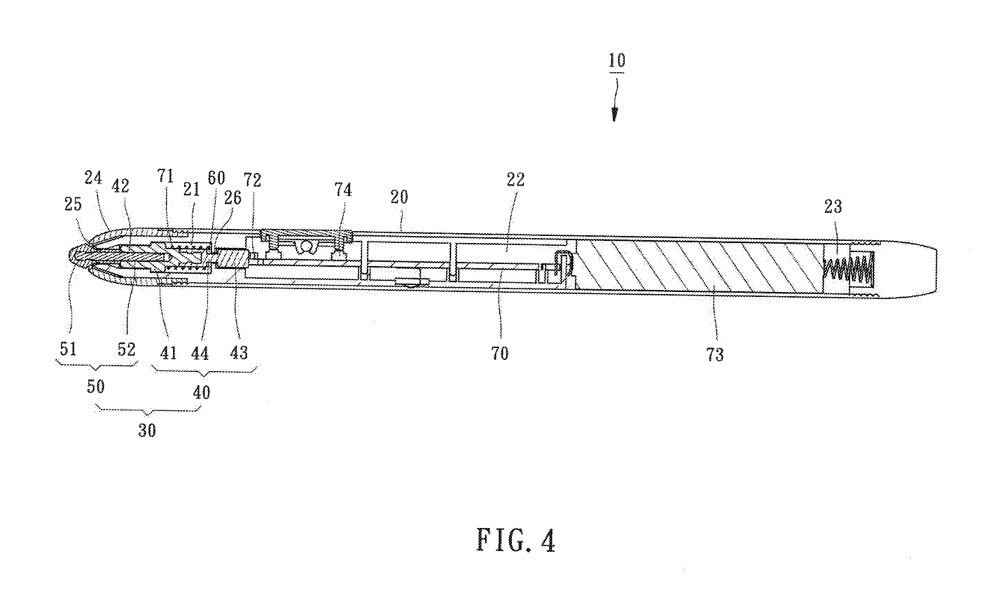

Referring to FIG. 1, an input device 10 for a touch interface 12 in accordance with a first preferred embodiment of the present invention is formed of a main body 20. As shown in FIGS. 2-4, the main body 20 is partitioned off to make a first chamber 21, a second chamber 22, and a third chamber 23. The main body 20 includes a front end 24 having an. opening 25 communicating with the first chamber 21. A through hole 26 is formed between the first and second chambers 21 and 22. The detailed descriptions and operations of these elements as well as their interrelations are recited in the respective paragraphs as follows.

A movable assembly 30 is mounted inside the first chamber 21 and includes a driven member 40 and a contact member 50. The driven member 40 has a metallic base 41 having a hollow portion 42 recessed inward from one side thereof, an extended portion 43 formed at the other side thereof, and a neck portion 44 formed between the extended portion 43 and the base 41 and having less width than those of the base 41 and the extended portion 43. In this embodiment, the extended portion 43 and the neck portion 44 are covered by a rigid plastic material as an example. The contact member 50 includes an end portion 51 and a fixed portion 52, both of which are made of electrically-conductive materials. The fixed portion 52 is inserted into the hollow portion 42. The driven member 40 and the contact member 50 are received in the first chamber 21. The accommodation space of the first chamber 21 is slightly bigger than that of the base 41. The end portion 51 of the contact member 50 extends out of the main body 20 through the opening 25. The extended portion 43 and the neck portion 44 pass through the through hole 26. The extended portion 43 faces the second chamber 22. A resilient member 60 is sleeved onto the neck portion 44. The resilient member 60 is a coil made of a high-density material as an example and directly stopped against between the base 41 and an internal wall of the first chamber 21 to jam the gap between the base 41 and the first chamber 21.

A circuit board 70 is mounted inside the second chamber 22 and electrically connected with an electrically-conductive member 71. The electrically-conductive member 71 is a spiral metallic wire as an example and mounted around the base 41, having two ends, one of which is electrically connected with the circuit board 70 and the other is electrically connected with the base 41 to make the contact member 50 and the driven member 40 be electrically connected with the circuit board 70 via the electrically-conductive member 71 for operating the touch interface 12. A sensor 72 is mounted to the circuit board 70 and adjacent to the through hole 26. In this embodiment, the sensor 72 is an optical sensor as an example. The extended portion 43 can interact with the sensor 72. When the extended portion 43 is shifted, the sensor 72 can generate a corresponsive signal indicative of the shift. A signal-processing module (not shown) electrically connected with the sensor 72 and a switch 74 for generating a corresponsive execution signal are mounted on the circuit board 70. The signal-processing module can process and transmit the signal indicative of the shift. A battery pack 73 is mounted inside the third chamber 23 for providing the whole power source for the input device 10. The circuit board 70 is electrically connected with the battery pack 73.

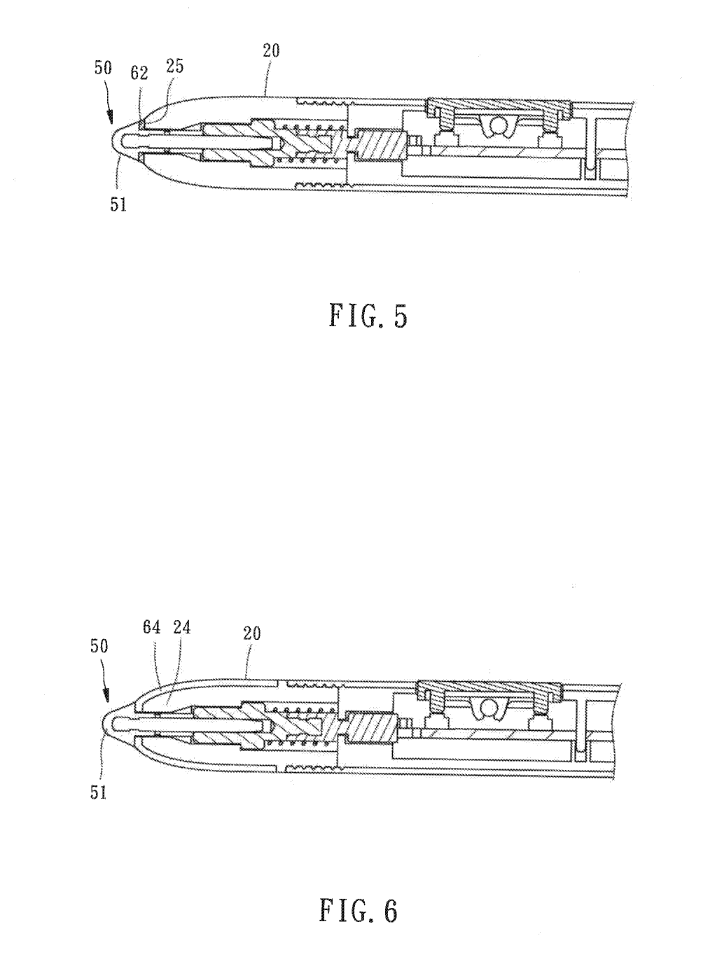

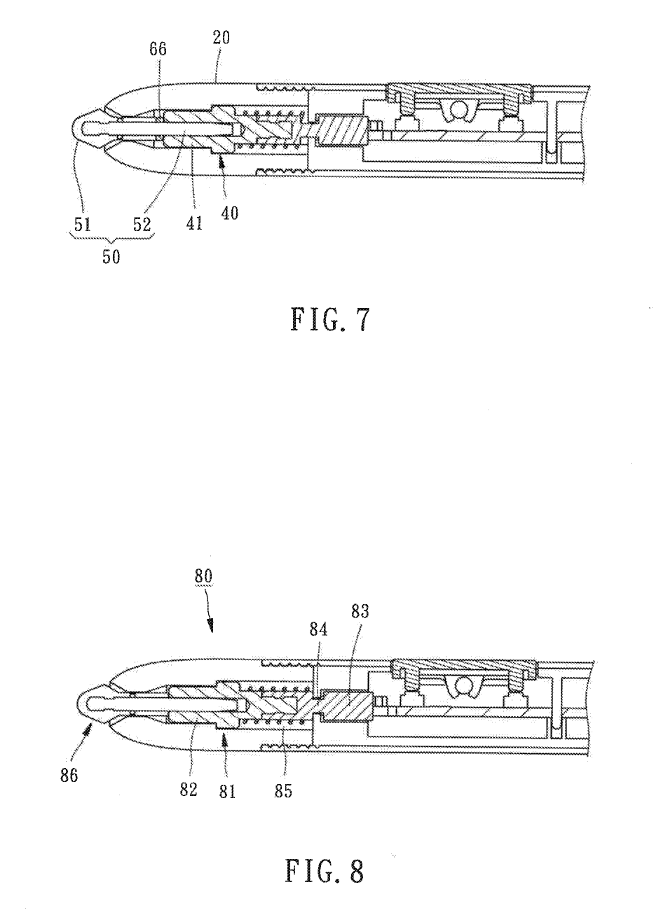

In light of the structure mentioned above, when the end portion 51 of the contact member 50 is stopped against the touch interface 12, the contact member 50 and the driven member 40 can be driven by a reverse applied force to make a little movement toward the inside of the main body 20. The resilient member 60 is stopped against between the base 41 and the internal wall of the first chamber 21, so the movement of the movable assembly 30 is limitedly and linearly variable subject to the resilience of the resilient member 60. The movement of the movable assembly 30 is also directly proportional to the user's applied downward force. Even if the user starts to apply a slight downward force only for contact with the touch interface 12, the movable assembly 30 can still make little movement relatively without any stasis. Through the interaction between the extended portion 43 and the sensor 72, the sensor 72 can accurately detect the movement variation of the movable assembly 30 for further communication and control via the signal-processing module and the touch interface 12. Thus, the structural features between the movable assembly 30 and the resilient member 60 can make the control of the operational force accurate and faithfully reflect the touch perception.

Where and how the resilient member is located is changeable. Referring to FIG. 5, the resilient member 62 can be mounted to the opening 25 of the main body 20 and located between the end portion 51 of the contact member 50 and the main body 20. Referring to FIG. 6, the resilient member 64 can cover the external surface of the front end 24 of the main body 20 and be located between the end portion 51 and the main body 20. Referring to FIG. 7, the resilient member 66 is sleeved onto the fixed portion 52 and located between the end portion 51 and the base 41. All of these alternative structures can reach the purpose of the present invention.

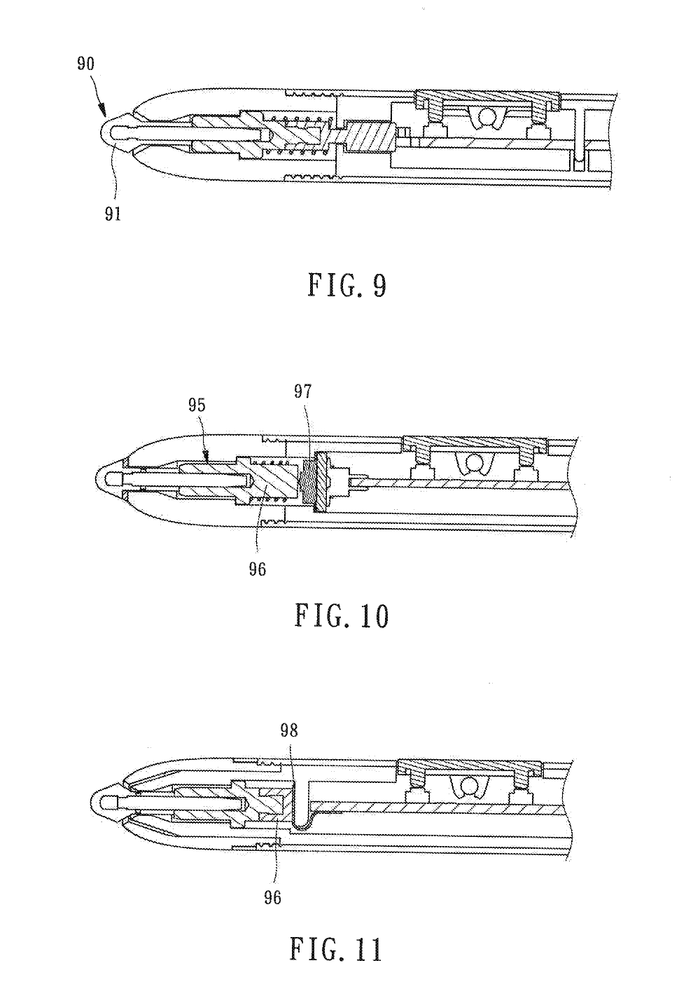

Referring to FIG. 8, an input device 80 for a touch interface in accordance with a second preferred embodiment of the present invention is similar to that of the first preferred embodiment, having the following differences. Each of the base 82, the extended portion 83, and the neck portion 84 of the driven member 81 is made of a high-density resilient material. The base 82 is stopped against the internal wall of the first chamber 85 to enable control of the movement of the contact member 86 by means of the resilient material of the base 82 while the contact member 86 is oppressed. Referring to FIG. 9, the end portion 91 of the contact member 90 can be made of an electrically-conductive and resilient high-density material to reach the same effect.

In addition to the optical sensor, the sensor of the present invention can be pressure-type sensor 97 or 98, against which the extended portion 96 of the driven member 95 can be directly stopped, as shown in FIGS. 10 and 11.

What is claimed is:

1. An input device for a touch interface, comprising:
a main body having an opening;
a sensor mounted to the main body;
a movable assembly movably mounted to the main body and having a driven member and a contact member, the contact member having an end portion, the driven member being mounted to the main body, the contact member being mounted to the driven member, the end portion extending out of the main body through the opening, whereby the sensor generates an electric signal corresponding to the position of the driven member while the movable assembly is moved relative to the main body; and
a resilient member mounted and directly stopped against between the movable assembly and the main body

2. The input device as defined in claim 1, wherein the main body comprises a first chamber internally; the opening communicates with the first chamber; the resilient member is directly stopped against between the movable assembly and an internal wall of the first chamber.

3. The input device as defined in claim 2, wherein the main body comprises a second chamber internally, a circuit board being mounted inside the second chamber and electrically connected with an electrically-conductive member, the electrically-conductive member being mounted around the driven member and having two ends, one of which is electrically connected with the circuit board and the other is electrically connected with the driven member to make the contact member and the driven member be electrically connected with the circuit board.

4. The input device as defined in claim 1, wherein the resilient member is mounted to the opening of the main body and located between the end portion of the contact member and the main body.

5. The input device as defined in claim 3, wherein the main body comprises a front end and the resilient member covers an external surface of the front end.

6. The input device as defined in claim 1, wherein the driven member comprises a base having hollow portion and the contact member comprises a fixed portion extending from the end portion and inserted into the hollow portion.

7. The input device as defined in claim 2, wherein the driven member comprises a base, an extended portion, and a neck portion located between the extended portion and the base, the driven member and the contact member being received inside the first chamber, the end portion of the contact member extending out of the main body through the opening, the extended portion facing a second chamber of the main body for interaction with the sensor, the neck portion being sleeved onto the resilient member.

8. An input device for a touch interface, comprising:
a main body having an opening;
a sensor mounted to the main body;
a movable assembly movably mounted to the main body and having a driven member and a contact member, the contact member having an end portion, the driven member being mounted to the main body, the contact member being mounted to the driven member, the end portion extending out of the opening, whereby the sensor generates an electric signal corresponding to the position of the driven member while the movable assembly is moved relative to the main body; and
a resilient member mounted and directly stopped against between the contact member and the driven member.

9. The input device as defined in claim 8, wherein the driven member comprises a base having a hollow portion formed at a side of the base; the contact member comprises a fixed portion extending from the end portion and inserted into the hollow portion; the resilient member being sleeved onto the fixed portion and located between the end portion and the base.

10. The input device as defined in claim 9, wherein the circuit board is electrically connected with a battery pack.
